(19) United States
(12) Patent Application Publication
(10) Pub. No.: US 2012/0086401 A1
(43) Pub. Date: Apr. 12, 2012

(54) CELL BALANCING CIRCUIT FOR USE IN A MULTI-CELL BATTERY SYSTEM

(75) Inventors: EDGARDO LABER, MONTE SERENO, CA (US); ANTHONY ALLEN, LOS GATOS, CA (US); CARLOS MARTINEZ, MORGAN HILL, CA (US)

(73) Assignee: INTERSIL AMERICAS INC., MILPITAS, CA (US)

(21) Appl. No.: 13/103,489

(22) Filed: May 9, 2011

Related U.S. Application Data
(60) Provisional application No. 61/390,758, filed on Oct. 7, 2010.

(51) Int. Cl. H02J 7/00

(52) U.S. Cl. 320/118

(57) ABSTRACT

An apparatus for balancing a multi-cell battery pack has a plurality of switchable loads. Each of the plurality of switchable loads are associated with one of a plurality of cells of a multi-cell battery. The plurality of switchable loads discharge an associated cell in a first mode and diverts part of a charging current away from the associated cell in a second mode responsive to a drive signal. A plurality of current mode driver circuits applies the drive signal to each of the plurality of switched loads.

### CROSS-REFERENCE TO RELATED APPLICATIONS

This application claims priority to U.S. Provisional Application No. 61/390,758, filed Oct. 7, 2010, entitled DRIVERS FOR CELL BALANCING CIRCUITS FROM AN INTEGRATED CIRCUIT IN A MULTI-CELL BATTERY SYSTEM, which is incorporated herein by reference.

### BRIEF DESCRIPTION OF THE DRAWINGS

For a more complete understanding, reference is now made to the following description taken in conjunction with the accompanying Drawings in which:

FIG. 1 illustrates a multi-cell battery charging system using a single current charging source;

FIG. 2 is a block diagram of a multi-cell battery driver and associated IC for operating the drivers in a multi-cell charging circuit; and

FIG. 3 illustrates the driver circuitries for the cell balancing circuitry of a multi-cell battery charging system.

### DETAILED DESCRIPTION

Referring now to the drawings, wherein like reference numbers are used herein to designate like elements throughout, the various views and embodiments of a cell balancing circuit for use in a multi-cell battery system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Multi-cell battery systems are used in a wide variety of electric powered devices such as hybrid or electric cars, power tools, electric bicycles and uninterrupted power supplies that are rapidly expanding. Cell balancing circuits are used with the battery packs associated with these devices. The battery packs include a plurality of cells that are connected in series. In each of these multi-cell battery applications, it is common to make a battery pack including a plurality of lithium ion cells each having a voltage of about 3.5 to 4 volts. By combining multiple of these 3.5 to 4 volt cells together, an overall multi-cell battery package with a higher voltage can be provided.

However, the cells associated with these multi-cell battery packs are not perfectly matched with each other and each of the individual cells can behave somewhat differently over an extended period of time. If each of these multiple cells within a multi-cell battery pack system are charged and discharged using a same charging and discharging current, the voltage across each of the cells will be different as the electrical characteristics of the cells are not exactly matched to each other. When charging a multi-cell configuration, the charging circuitry stops when one of the cells within the multi-cell pack reaches a certain maximum safe voltage. While discharging, the system stops discharging when a cell reaches a certain minimum safe voltage. Thus, battery usage is not optimized in these cases since only the limiting cells within the multi-cell pack are fully charged or discharged. A balancing circuit equalizes the voltage at the cells to optimize the battery pack usage.

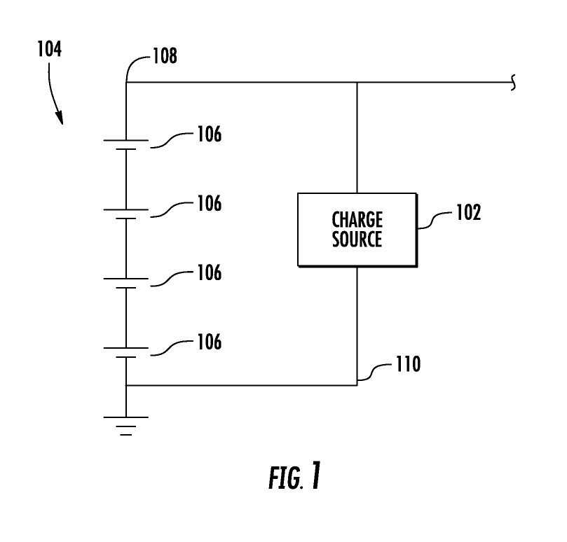

Referring now to FIG. 1, there is illustrated a configuration when only a single charging source 102 is used for charging a multi-cell battery pack 104 including a plurality of individual cells 106. The multi-cell battery 104 includes a plurality of individual cells 106 connected between a positive terminal node 108 and a negative terminal (ground) node 110. Between each of the positive node 108 and negative node 110 is a series connection of a plurality of individual cells 106. The positive terminal of each cell 106 is connected to the negative terminal of an adjacent cell. The positive terminal of the last cell in the chain has its positive terminal connected to the positive node 108, and the negative terminal of the last cell at the opposite end of the series chain is connected to the ground node 110.

The charging source 102 provides a charging current through each of the series connected cells 106. However, only a single charging current is provided from the charging source 102 as only a single charging path is provided through the individual cells 106. Since only a single charging current is used, and the cells 106 are not perfectly matched, the differences in the cells will cause a different voltage across each of the individual cells 106. Thus, as mentioned previously, the charger 102 will only charge the battery 104 to a level of a maximum safe voltage for one of the cells 106 within the battery pack 104 and will stop discharging when one of the cells 106 reaches its minimum safe voltage. Thus, much more efficient use of a multi-cell battery pack 104 could be accomplished by individually controlling the charging and/or discharging currents applied to each of the cells 106.

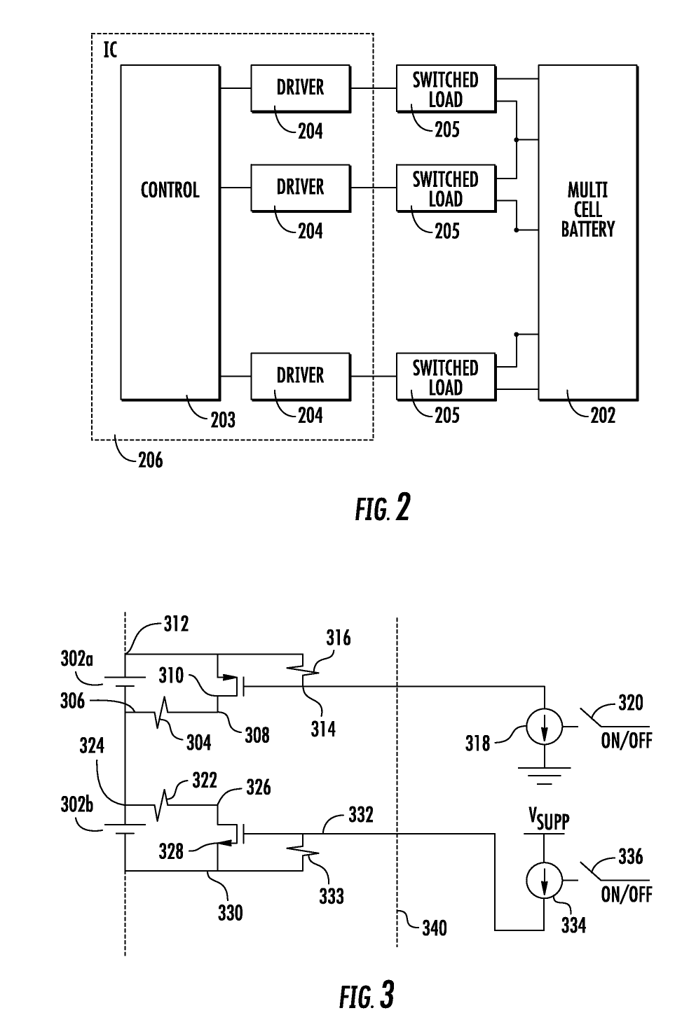

Referring now to FIG. 2, there is illustrated a general block diagram of a circuit including a multi-cell battery 202. Each cell within the multi-cell battery 202 is associated with a driver circuit 204 and a switchable load circuit 205. The switchable load circuit 205 may be located internally or externally of the integrated circuit (IC) 206. The IC 206 and multi-cell battery 202 can be implemented within a larger electrically powered system, such as an electrical vehicle. The operation of the driver circuit 204 is controlled by control circuits 203 in an integrated circuit 206. A switchable load 205 can connect or disconnect in parallel to an individual cell 203 of the multi-cell battery 202, in response to a control signal from a driver circuit 204. By selectively connecting one or more of the switchable loads, cells whose voltages are higher than voltages at other cells, can be individually partially discharged to equalize the voltage of various cells within a battery pack. In addition, while the battery pack 104 of FIG. 1 is being charged with current sourced from the charge source 102, the charging current can be partially diverted away from one or more cells within the pack by enabling (turning on) the switchable load associated with each of those specific cells, and therefore slowing down the increase in voltage on those cells, to equalize the voltage of different cells.

Referring now to FIG. 3, there is illustrated an embodiment of the driver and switchable load circuitries associated with a multi-cell battery including a plurality of cells 302. In the first configuration a cell 302a is connected in series with a plurality of other cells both above and below cell 302a. Cell 302a is charged or discharged through associated current flowing through the positive and negative terminals of the cell. A resistor 304 is connected between the negative terminal 306 of cell 302a and node 308. A P-channel transistor 310 has its source/drain path connected between the positive terminal 312 of cell 302a and node 308. The gate of transistor 310 is connected to node 314. A resistor 316 is connected between node 312 and node 314. A current source 318 is connected between node 314 and ground. A control switch 320 is used for receiving a control input from an associated control circuit to turn on and off current source 318. By controlling whether current source 318 is turned on or off, P-channel transistor 310 can be turned on and off. In this way, part of the charging current applied to cell 302a may be shunted, decreasing the current charging a specific cell. If the battery is not being charged, turning on the P-channel transistor would discharge the associated cell 302a.

In a second configuration illustrated in FIG. 3, the cell 302b is again connected in series with a number of cells within a multi-cell battery pack but only cell 302b is described here. A resistor 322 is connected between the positive terminal of cell 302b at node 324 and node 326. An N-channel transistor 328 is connected between node 326 and the negative terminal of cell 302 at node 330. The gate of N-channel transistor 328 is connected to current source 334 at node 332. A resistor 333 is connected between node 332 and the negative terminal of battery 302 at node 330. Current source 334 is connected between the supply voltage V_{SUPP} and node 332. Current source 334 provides a control current that turns on or off the switchable load composed of transistor 328 and resistor 322. A control switch 336 responsive to a control signal from the associated control circuit turns on and off the current source 334 which turns N-channel transistor 328 on and off. In this way, part of the charging current applied to cell 302b may be shunted, decreasing the current charging a specific cell. If the battery is not being charged, turning on the N-channel transistor would discharge the associated cell 302b.

The cell balancing circuits of FIG. 3 are implemented using either power NMOS transistors 328 or power PMOS transistors 310, or a combination of PMOS and NMOS power transistors. The transistors may be located within the IC or outside of the IC. Locating the transistors within the IC can be appropriate for some low power applications. Various combinations and variations of the circuits of FIG. 3 may be used together or separately. Examples of variations include the usage of a different type of active switch in the switchable loads, removing resistors 304 and 322 and using the intrinsic switch resistance instead, adding components for transient protection, etc. The integrated circuit 206 of FIG. 2 drives the switchable load circuits 204 associated with each of cells 302, the current sources 318 and 334 and associated driving control switches 320 and 336. When the integrated circuit drives a current into or out of the drive circuits using the current sources 318 and 334, current flows through the resistors connected between the gates and sources of the transistors 310, 328 turning them “on.” When the IC current is turned “off,” the associated MOSFET is turned “off.” If only one type of driver is used (NMOS or PMOS) rather than a combination of both, the integrated circuit will require a charge pump circuit or some other extra power source to drive the cell balancing circuits close to either ground or the main supply terminal.

In prior art configurations, the driver circuit for the FET in the balancing switchable load derives its voltage from the cell being balanced. Thus, the FET within the drive circuit must have low threshold voltages to be able to turn on the FET at low voltages. This can lead to heating of the balancing FET or a failure of the FET to turn on. For the disclosed approach, FET transistors 310 and 328 can generate a high enough gate voltage of 8 volts. This ensures that the FET transistors 310 and 328 are fully turned on regardless of the voltage of the cell being balanced.

In prior art configurations, the integrated circuit drivers driving switchable loads outside that integrated circuit have been voltage mode drivers. For this disclosure, the drivers are current mode drivers with much larger common mode capability than voltage mode drivers used in prior art. The described implementation is more reliable and flexible than solutions using voltage mode drivers and external switchable loads or solutions using integrated switchable loads. The solution of FIG. 3 does not require multiple low impedance floating ground and/or supply rails for each driver. The ESD and latch up protection using this solution is simplified at both the IC and system level. Existing voltage mode drive systems use a voltage driver powered from the adjacent voltage cells. This places limitations upon protection that can be applied to the driver circuit and increases the risk of component failure during hot plug events. The described solution employs current sources to drive the switching elements in the switchable loads. The current sources are connected to the main supply rails of the associated parts. This enables the drivers to be easily protected against external influences without compromising the safety of the system.

It will be appreciated by those skilled in the art having the benefit of this disclosure that this cell balancing circuit for use in a multi-cell battery system provides an improved manner for balancing individual cells of a multi-cell battery. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An apparatus for balancing a multi-cell battery pack, comprising:
a plurality of switchable loads, each associated to one of a plurality of cells of a multi-cell battery, for discharging an associated cell in a first mode and for diverting part of a charging current away from the associated cell in a second mode, responsive to a drive signal; and
a plurality of current mode driver circuits for applying the drive signal to each of the plurality of switched loads.

2. The apparatus of claim 1, wherein at least one of the plurality of current mode driver circuits further includes:
a current source for generating the drive signal; and
a switching circuit, wherein the switching circuit turns on and off the associated current source responsive to a control signal.

3. The apparatus of claim 2, wherein the plurality of current mode driver circuits further includes a charge pump for supplying the drive signal.

4. The apparatus of claim 1, wherein at least one of the plurality of switchable load circuits further includes:
a switching device having a control terminal connected to receive the drive signal;
a first resistor connected between a terminal of the associated battery cell and a first output terminal of the switching device; and
a second resistor connected between the control terminal and a second output terminal of the switching device.

5. The apparatus of claim 2, wherein the switching devices further comprises a bipolar transistor.

6. The apparatus of claim 2, wherein the switching devices further comprises a field effect transistor.

7. The apparatus of claim 1, wherein the current mode driver circuits are located within an integrated circuit and the switchable loads are not located in the integrated circuit that contains the driver associated with them.

8. A method for balancing a multi-cell battery pack, comprising the steps of:
selectively switching a plurality of load current paths in parallel to each of a plurality of battery cells of a multi-cell battery, responsive to a plurality of drive signals;
discharging an associated cell in a first mode when a load current path is switched in parallel with the associated cell;
diverting part of the charging current away from the associated cell in a second mode when a load current path is switched in parallel with the associated cell; and
applying the drive signal to each of the plurality of switched loads.

9. The method of claim 8, wherein the step of selectively switching further comprises the step of applying a drive signal to a switched load to selectively switch the plurality of load current paths.

10. The method of claim 8, wherein the step of selectively switching further comprises the steps of:
opening and closing a switch associated with a current source;
turning on the current source responsive to the closing of the switch; and
turning off the current source responsive to the opening of the switch.

11. An apparatus for balancing a multi-cell battery pack, comprising:
a plurality of switchable loads, each associated to one of a plurality of cells of a multi-cell battery, for discharging an associated cell in a first mode and for diverting part of a charging current away from the associated cell in a second mode, responsive to a drive signal, wherein each of the plurality of switchable load circuits further includes:
a switching device having a control terminal connected to receive the drive signal;
a first resistor connected between a terminal of the associated battery cell and a first output terminal of the switching device;
a second resistor connected between the control terminal and a second output terminal of the switching device;
a plurality of current mode driver circuits for applying the drive signal to each of the plurality of switched loads, wherein each of the plurality of current mode driver circuits further includes:
a current source for generating the drive signal; and
a switching circuit, wherein the switching circuit turns on and off the associated current source responsive to a control signal.

12. The apparatus of claim 11, wherein the plurality of current mode driver circuits further includes a charge pump for supplying the drive signal.

13. The apparatus of claim 11, wherein the switching devices further comprises a bipolar transistor.

14. The apparatus of claim 11, wherein the switching devices further comprises a field effect transistor.

15. The apparatus of claim 11, wherein the current mode driver circuits are located within an integrated circuit and the switchable loads are not located in the integrated circuit that contains the driver associated with them.

16. An apparatus, comprising:
an electrically powered device;
a multi-cell battery back for powering the electrically powered device;
a plurality of switchable loads, each associated to one of a plurality of cells of the multi-cell battery, for discharging an associated cell in a first mode and for diverting part of a charging current away from the associated cell in a second mode, responsive to a drive signal; and
a plurality of current mode driver circuits for applying the drive signal to each of the plurality of switched loads.

17. The apparatus of claim 16, wherein at least one of the plurality of current mode driver circuits further includes:
a current source for generating the drive signal; and
a switching circuit, wherein the switching circuit turns on and off the associated current source responsive to a control signal.

18. The apparatus of claim 16, wherein at least one of the plurality of switchable load circuits further includes:
a switching device having a control terminal connected to receive the drive signal;
a first resistor connected between a terminal of the associated battery cell and a first output terminal of the switching device; and
a second resistor connected between the control terminal and a second output terminal of the switching device.

19. The apparatus of claim 16, wherein the current mode driver circuits are located within an integrated circuit and the switchable loads are not located in the integrated circuit that contains the driver associated with them.
